(19) United States
(12) Patent Application Publication
(10) Pub. No.: US 2004/0156636 A1
(43) Pub. Date: Aug. 12, 2004

(54) Optical temporal demultiplexer

(76) Inventor: Erwan Pincemin, Gommenec'h (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/479,905

(22) PCT Filed: Jun. 3, 2002
(86) PCT No.: PCT/FR02/01862

(30) Foreign Application Priority Data
Jun. 5, 2001 (FR) 01/07304

(51) Int. Cl. H04J 14/02

(52) U.S. Cl. 398/79

(57) ABSTRACT

The invention provides a time-division demultiplexer apparatus for an optical signal, the apparatus comprising a first coupler (3) which splits the optical signal for demultiplexing into two signals propagating in two different branches (4, 5) of the apparatus, and a second coupler (6) which reunites the signals from the two branches (4, 5), the apparatus being characterized in that one of the branches (5) includes processor means (51-55) for producing a signal at the inlet of the second coupler (6) in the form of light pulses having a repetition rate that is a function of the signal that is to be obtained at the output from the apparatus, said pulses being slightly early relative to the signal which is to be demultiplexed; and in that the intensity of the light pulses is suitable for saturating an absorber medium (7) extending after the second coupler.

### GENERAL TECHNICAL FIELD

The invention relates to time-division demultiplexers.

More particularly, it relates to a demultiplexer for demultiplexing an optical signal in time-division multiplex by using all-optical methods only.

### STATE OF THE ART

The capacity of high data rate optical networks has been increasing with the development of information technologies. Optical networks using optical time-division multiplexing (OTDM) methods and wavelength division multiplexing (WDM) methods are becoming more widespread.

After transmission, such multiplexing methods require demultiplexing methods that are ultra-fast.

In general, the demultiplexing methods are cross-phase modulation (XPM) in a dispersion-shifted fiber (DSF) or in a non-linear optical loop mirror (NOLM), or four-wave mixing in a dispersion-shifted fiber or a semiconductor amplifier. Another method of demodulation is demodulation using an electro-absorption modulator.

The above methods nevertheless present drawbacks.

They are often difficult to implement since the devices they use include elements that are complicated.

In addition, they are not totally passive nor are they based on an all-optical principle.

### SUMMARY OF THE INVENTION

The invention seeks to mitigate those drawbacks.

In particular, it is advantageous to provide a demultiplexer device that comprises passive and all-optical elements, only.

To this end, the invention provides a time-division demultiplexer apparatus for an optical signal, the apparatus comprising a first coupler which splits the optical signal for demultiplexing into two signals propagating in two different branches of the apparatus, and a second coupler which reunites the signals from the two branches, the apparatus being characterized in that one of the branches includes processor means for producing a signal at the inlet of the second coupler in the form of light pulses having a repetition rate that is a function of the signal that is to be obtained at the output from the apparatus, said pulses being slightly early relative to the signal which is to be demultiplexed; and in that the intensity of the light pulses is suitable for saturating an absorber medium extending after the second coupler.

The invention is advantageously associated with the following characteristics taken singly or in any technically feasible combination:

the processor means comprise means for transforming the optical signal from the first coupler into an electrical signal, synchronizing means so that said electrical signal has a repetition rate identical to the bit rate of the signal to be demultiplexed, frequency divider means, means for imparting a time shift between the two signals propagating in the branches, and a laser source;

the means for transforming the optical signal into an electrical signal comprise a photodiode;

the synchronizing means comprise means suitable for reconstituting a synchronizing clock signal;

the clock forming means have a high Q factor;

the frequency divider means divide the frequency of the signal from the synchronizing means by a factor which is a multiple of two;

the laser source is controlled by the electrical signal whose frequency has been divided and which has been shifted; and

the saturable absorber comprises an InGaAs/InAlAs structure.

The invention also provides the demultiplexing method implemented by the apparatus of the invention.

### BRIEF DESCRIPTION OF THE FIGURES

Other characteristics and advantages of the invention appear from the following description which is purely illustrative and non-limiting, and which should be read with reference to the accompanying figures, in which:

FIG. 1 is a diagram of the demultiplexer apparatus of the invention;

FIG. 2 shows the signal propagating in the branch 2 of the FIG. 1 apparatus;

FIG. 3 shows the signal propagating in the branch 7 of the FIG. 1 apparatus, upstream from the saturable absorber; and

FIG. 4 shows the signal propagating in the branch 7 of the FIG. 1 apparatus downstream from the saturable absorber, i.e. the demultiplexed signal.

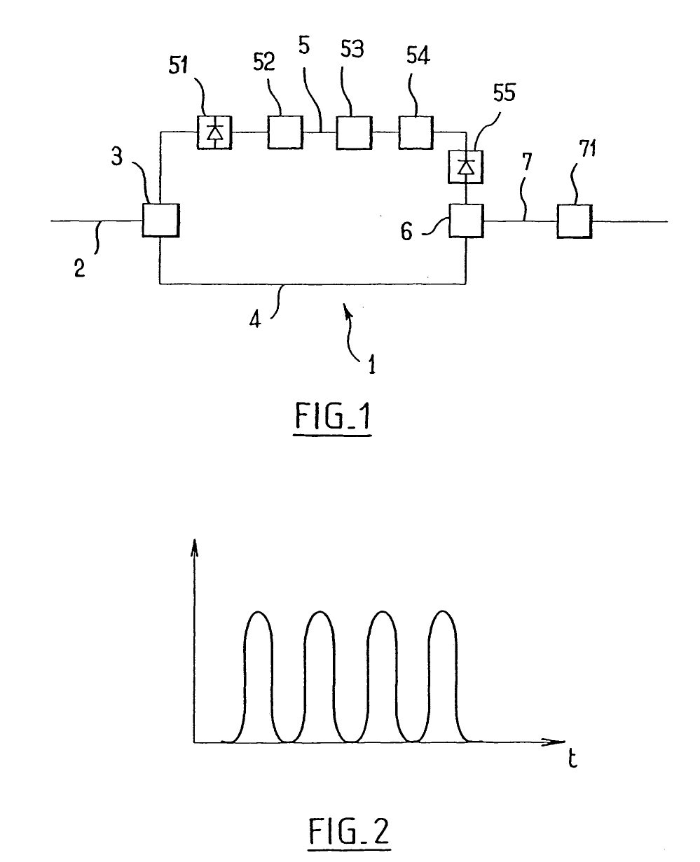

FIG. 1 shows demultiplexer apparatus 1 comprising a plurality of branches.

A branch 2 conveys the optical signal that is to be demultiplexed. It is split into two branches 4 and 5 extending between two couplers 3 and 6.

The branch 5 has signal processor means described in greater detail below.

After the second coupler 6, the branch 7 has demultiplexer means enabling a demultiplexed signal to be obtained at the output from the branch 7.

### DETAILED DESCRIPTION OF THE APPARATUS

The multiplexed signal propagating in the branch 2 has a bit rate of 40 gigabits per second (Gbit/s), for example. It is applied to a 50%/50% coupler 3 which splits the signal into two identical signals. These two signals then propagate in two branches 4 and 5.

The branch 5 includes photodiode-forming means 51 transforming the light signal coming from the coupler 3 into an electrical signal suitable for processing.

The electrical signal output by the diode 51 is applied to means 52 suitable for reconstituting a synchronization clock signal. The means 52 serve to output a signal having a repetition rate that is identical to the bit rate of the multiplexed signal. The means 52 present a large Q factor. Q factor is defined as the ratio of the center frequency of a filter included in the means 52, which frequency is substantially equal to 40 GHz, over the width in frequency terms of the −3 decibel (dB) passband of the filter. The Q factor of the means 52 used in the apparatus preferably has a value lying in the range 500 to 1000.

The synchronized signal is then applied to a frequency divider 53. By way of example, the frequency divider 53 may divide the frequency of the signal coming from the clock 52 by a factor which is a multiple of two. The division factor may be equal to four, for example. Under such circumstances, the objective is to retrieve a signal having a bit rate of 10 Gbit/s from the output of the apparatus 1.

The frequency-divided signal is applied to a time-shift generator 54. At the output from the generator 54, the signal is slightly early relative to the signal that is to be obtained after demultiplexing.

The signal processed by the elements 52, 53, and 54 controls a laser 55 which generates an optical probe in the form of light pulses. This probe constitutes a binary sequence of “1” signals only. The repetition rate of the light pulse representing binary “1” is, for example, one-fourth the bit rate of the multiplexed signal.

The binary probe is coupled by a coupler 6 to the multiplexed signal which has propagated in the branch 4 extending from the outlet of the coupler 3.

The output from the coupler 6 is connected to a branch 7 which includes means 71 forming a saturable absorber. The absorbent material of the absorber saturates fast and is known per se so it is not described in greater detail below. It can be constituted, for example, by an InGaAs/InAlAs structure.

The desired demultiplexed signal is obtained from the output of the absorber 71.

### Operating Principle

FIG. 2 shows the multiplexed optical signal, referred to as the OTDM signal, that enters the demultiplexer apparatus. The signal for demultiplexing has a binary rate of 40 Gbit/s, for example.

By way of example, the signal for demultiplexing comprises four multiplexed signals. It is desired to obtain one of these signals at the output from the apparatus 1.

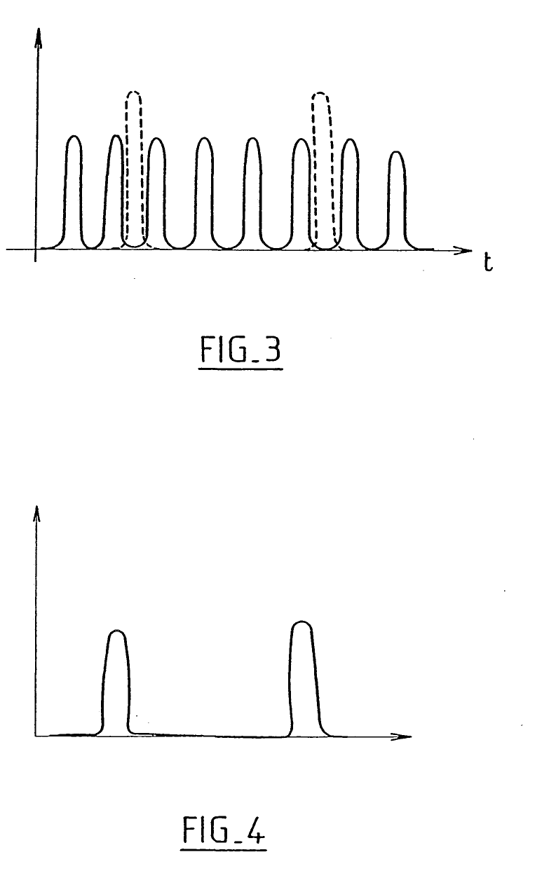

FIG. 3 shows the signal that results from coupling the signal from the laser source 55 with the signal propagating in the branch 4.

The signal from the laser source has a pulse repetition frequency that is one-fourth that of the signal to be demultiplexed. It is also slightly early relative to the signal that is to obtained at the output from the demultiplexer. It is also of light intensity that is suitable for saturating the saturable absorber 71.

Thus, when the probe signal reaches the saturable absorber 71, the probe energy is such that it quickly saturates the saturable absorber 71. When saturated in this way, the absorber 71 is transparent for the signal coming from the branch 4 and immediately following the peak of the probe signal.

As a result, this is the signal that is delivered to the output of the absorber 71.

However, the absorber 71 desaturates quickly. Thus, the pulses of the multiplexed signal which are not immediately preceded by a probe signal peak are absorbed by the absorber 71. The absorbed signal does not appear at the output of the absorber 71.

Energy considerations also need to be taken into account for the signal to be demultiplexed. This signal must have sufficient energy to pass through the saturated absorber, while also being suitable for being absorbed by the absorber when the probe signal peak was not present immediately prior to a peak in the multiplexed signal.

FIG. 4 shows the demultiplexed signal output by the absorber 71. This is a signal having a bit rate of 10 Gbit/s.

The above description relates to demultiplexing a signal having a bit rate of 40 Gbit/s. However, the invention is equally applicable to signals having any bit rate. It-is preferably applied to the bit rate used in the various standards commonly in use in telecommunications, e.g. 20 Gbit/s, and also to signals at rates of 160 Gbit/s or 640 Gbit/s.

1. Time-division demultiplexer apparatus for an optical signal, the apparatus comprising a first coupler (3) which splits the optical signal for demultiplexing into two signals propagating in two different branches (4, 5) of the apparatus, and a second coupler (6) which reunites the signals from the two branches (4, 5),
the apparatus being characterized in that one of the branches (5) includes processor means (51-55) for producing a signal at the inlet of the second coupler (6) in the form of light pulses having a repetition rate that is a function of the signal that is to be obtained at the output from the apparatus, said pulses being slightly early relative to the signal which is to be demultiplexed; and
in that the intensity of the light pulses is suitable for saturating an absorber medium (71) extending after the second coupler.

2. Apparatus according to claim 1, characterized in that the processor means comprise means (51) for transforming the optical signal from the first coupler (3) into an electrical signal, synchronizing means (52) so that said electrical signal has a repetition rate identical to the bit rate of the signal to be demultiplexed, frequency divider means (53), means (54) for imparting a time shift between the two signals propagating in the branches, and a laser source (55).

3. Apparatus according to claim 1 or claim 2, characterized in that the means (51) for transforming the optical signal into an electrical signal comprise a photodiode.

4. Apparatus according to any one of claims 1 to 3, characterized in that the synchronizing means (52) comprise means suitable for reconstituting a synchronizing clock signal.

5. Apparatus according to claim 4, characterized in that the clock forming means have a high Q factor.

6. Apparatus according to any one of claims 1 to 5, characterized in that the frequency divider means (53) divide the frequency of the signal from the synchronizing means by a factor which is a multiple of two.

7. Apparatus according to any one of claims 1 to 6, characterized in that the laser source (55) is controlled by the electrical signal whose frequency has been divided and which has been shifted.

8. Apparatus according to any one of claims 1 to 7, characterized in that the saturable absorber (71) comprises an InGaAs/InAlAs structure.

9. A method of time-division demultiplexing an optical signal, the method comprising the steps of:
using a first coupler to split the optical signal for demultiplexing into two signals;
injecting the two signals so that they propagate along two different branches extending from the first coupler; and
reuniting the signals from the two branches in a second coupler;
the method being characterized by the steps of:
processing the signal propagating in one of the two branches to obtain a signal at the input of the second coupler in the form of light pulses having a repetition rate that is a function of the signal that is to be obtained at the output from the apparatus, these pulses being slightly early relative to the signal that is to be demultiplexed; and
injecting the light pulses output by the second coupler into an absorber medium, the intensity of the pulses coming from the processed signal being suitable for saturating said absorber medium, the medium as saturated in this way allowing the pulses that are to be demultiplexed to pass through.

10. A method according to claim 9, characterized in that processing of the signal in one of the two propagation branches comprises the following steps:
transforming the optical signal from the first coupler into an electrical signal;
synchronizing said electrical signal so that it has a repetition rate identical to the bit rate of the signal to be demultiplexed;
dividing the frequency of the synchronized signal;
imparting a time shift between the two signals propagating in the branches so that the signal as processed in this way is early relative to the signal that is to be demultiplexed; and
generating light pulses under the control of the signal as processed in this way.
